(19) United States
(12) Patent Application Publication
(10) Pub. No.: US 2003/0075915 A1
(43) Pub. Date: Apr. 24, 2003

(54) Slide hatch for bulk carrier

(76) Inventor: S.Y. Kim, Hayward, CA (US)

Correspondence Address: RICHARD ESTY PETERSON, PATENT ATTORNEY, 1905-D PALMETTO AVENUE, PACIFICA, CA, 94044, US

(21) Appl. No.: 10/038,896

(22) Filed: Oct. 24, 2001

(51) Int. Cl. B60P 3/22

(52) U.S. Cl. 280/838

(57) ABSTRACT

An improved slide hatch for a bulk carrier vehicle for removing a hatch cover from an access port on the top of a carrier tank on the vehicle, the slide hatch including a slide carriage connected to the hatch cover and to an actuator which displaces the slide carriage and hatch cover with the slide carriage mounted on a guide rail and connected to an improved, distributed-force cam mechanism for forcing the cover against the access port when the cover is displaced over the port for sealing the tank.

### BACKGROUND OF THE INVENTION

This invention is related to my invention disclosed in U.S. Pat. No. 6,196,590 BI, issued Mar. 6, 2001, entitled, “Slide Hatch For Bulk Carrier.”

The present invention relates to an improved slide hatch for a bulk carrier, in particular, a slide hatch for a vehicle carrier for dry cement. The slide hatch can be used on any bulk carrier vehicle of the type used for transport of dry powdered or granular material that is free flowing in a hopper style container.

This description utilizes a cement carrier as a preferred example of the transport carrier contemplated. Bulk transport of dry cement is accomplished utilizing a gondola-style trailer that is loaded with cement from a top port by means of a hose or chute. Typically, the gondola has a tank with sloping sides that converge to a bottom discharge for gravity feed of the cement to a discharge hose that is used to pneumatically deliver the bulk cement to a destination for storage or mixing. To assist in the discharge of the fine powder cement, the gondola tank is pressurized to both compensate for volumetric displacement by the discharging cement and to assist in moving the cement to the discharge pump.

To maintain a pressure within the gondola tank, the hatch cover must have a sealed engagement with the hatch port at the top of the tank. Typically, the hatch cover is connected to the tank with a hinge and a series of threaded dogs mounted around the hatch cover. When the tank is refilled, the hatch cover must be opened which has customarily required that the driver or assistant climb to the top of the trailer and manually disengage the tie-down dogs to open the hatch. Not only is this task time consuming, but because of the configuration of the tank and carrier trailer, the task is dangerous as well.

The slide hatch for bulk carriers described in U.S. Pat. No. 6,196,590 BI incorporated a cam mechanism for sliding and raising or lowering the hatch cover over the access port of the carrier tank. The design of the cam mechanism provided a single axis of interconnection between the hatch cover and the displacement mechanism which engages the rim of the access port to effect the hold down. It has been found that, in certain instances, the sealing of the hatch cover is such that the pressure in a pressurized tank can result in the escape of pressurized air at the fore or aft portion of the rim. Since the axis of interconnection of the cam mechanism does not always position itself exactly across the center of the hatch, the force of the hatch cover on the rim is not evenly disposed around the rim, particularly at the fore or aft portion of the rim.

The cumulative pressure on the hatch cover having a tank pressure of 10-15 p.s.i. exerts a 3,000-4,000 pound force that tends to deform the cover. Deformation of the hatch cover exacerbates the air leakage problem at the fore and aft portion of the rim.

The improved slide hatch of this invention addresses deficiencies in the previously invented slide hatch assembly and greatly improves sealing under the harsh operating conditions encountered by bulk carriers.

The improved slide hatch for bulk carriers of this invention is designed to enable removal of a hatch cover by an automatic or manual actuator and improve the sealing of the cover when replaced. The system for displacing the hatch cover is designed to not only position the hatch cover over the access port but to forcibly seat the hatch cover on the port rim to create a hermetic seal for allowing internal pressurization of the gondola tank. In this manner removal and replacement of the hatch cover can be accomplished automatically with a piston type actuator operated from inside or outside the vehicle cab without having to climb on top of the tank.

### SUMMARY OF THE INVENTION

The improved slide hatch for bulk carriers of this invention comprises an actuator operated hatch cover for the access port of a vehicle bulk carrier. In particular, the slide hatch is designed for a bulk dry power material carrier that is customarily pressurized to assist in pneumatically discharging the transported material to a storage or mixing facility. The typical vehicle carrier for dry material includes a gondola tank having a top hatch that covers an access port for filling the gondola tank with a bulk material such as dry cement. The access port also functions as a manhole for entry into the tank for clean-out or repair. Because the hatch is pressurized during discharge of the transported material, the hatch must be secured with sufficient force to withstand the internal pressurization.

The improved slide hatch of this invention permits removal and replacement of the hatch to be accomplished without having to climb onto the top of the gondola tank and manually remove a series of tie-down dogs. This task must be performed before the vehicle is moved into position for loading of the carrier with the bulk material. Not only is this task time consuming, it is dangerous and can result in injury. Customarily, a ladder on the carrier is provided to ascend to the top of the tank which may be contoured with a narrow access between longitudinal reinforcement members for the tank. After the carrier tank has been filled with material, the cover must be replaced and secured. The slide hatch of this invention includes an improved hatch mechanism for removing and replacing the hatch cover over an access port. The improved hatch mechanism utilizes a distributed-force cam mechanism that securely seats the hatch cover on the access port.

The improved slide hatch distributed-force cam mechanism includes a multiple axis engagement system that in the preferred embodiment provides two spaced axis of interconnection between the hatch cover and the displacement mechanism. In this manner, the force holding down the hatch cover is not located across the center of the hatch, but is positioned both fore and aft of the centerline. This provides for a more evenly distributed force around the cover eliminating leakage. Other improvements, including an improved collar around the rim of the access port and alternate seals, enhance the performance of the system in the field. These and other features will become apparent upon a detailed consideration of the preferred embodiments.

### BRIEF DESCRIPTION OF THE DRAWINGS

FIG. 1 is a perspective view of a bulk material carrier of the general type in which the schematically shown slide hatch is installed.

FIG. 2 is a top partial view of the slide hatch of FIG. 1 with the hatch cover in the open position.

FIG. 3 is an enlarged, partial side view of the slide hatch of FIG. 2.

FIG. 4 is a partial top view of a roller carriage shown in part in FIG. 3.

FIG. 5 is a partial end view of the slide hatch of FIG. 2.

FIG. 6 is a partial side view of a cam mechanism guide track shown in part in FIG. 2.

FIG. 7 is a partial bottom view of a hatch cover of the slide hatch of FIG. 2.

FIG. 8 is a partial cross-sectional view of a seated hatch cover and alternate seal.

### DETAILED DESCRIPTION OF THE PREFERRED EMBODIMENTS

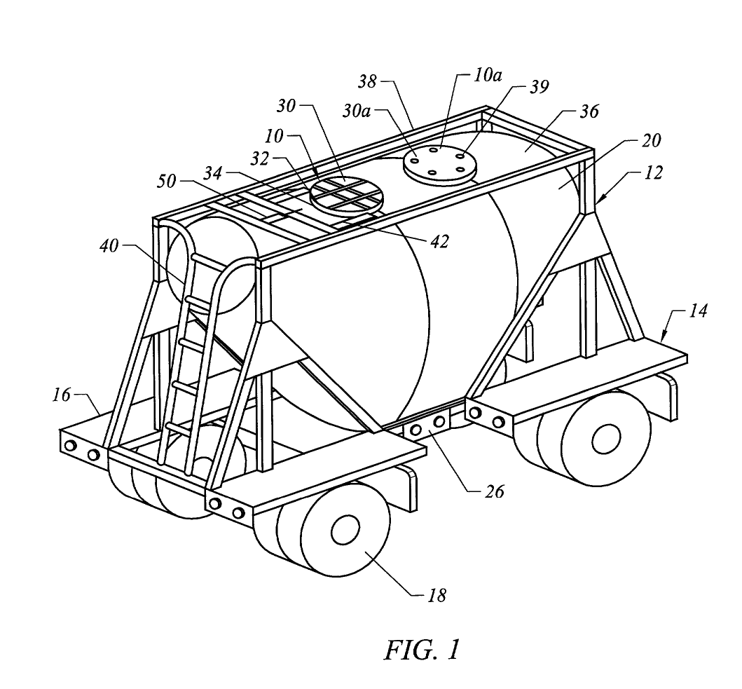

Referring to FIG. 1, the slide hatch, designated generally by the reference numeral 10, is shown as an assembly at the top of a bulk carrier 12. The bulk carrier 12 is typical of the type of transport carrier used for dry bulk material such as cement, flour, grain and other granular or powdered materials. In the embodiment of FIG. 1, the bulk carrier 12 comprises a trailer 14 with a carriage 16 having transport wheels 18 for transporting a carrier tank 20 mounted in a frame 25 on the carriage 16. The carrier tank 20 customarily has sloping end walls 22 that converge to a discharge (not visible) where the transported material is removed by a pump apparatus 26. To assist in the removal of the transported material, the carrier tank 20 is maintained under pressure during discharge through a pneumatic pipe system (not shown).

The slide hatch 10 at the top of the carrier 20 includes a hatch cover 30 that caps an access port 32 having a rim 34 that is raised from the curved top surface 36 of the carrier tank 20. Alongside the raised rim 34 are two reinforcing beams 38 that act as stiffeners for the tank top 36. An access ladder 40 that provides access to the tank top 36 is used for maintenance and clean-out of the tank through the access port 32. The access port 32 functions both as a manhole and a filler port for filling the carrier tank with dry material using a chute or filler hose.

Prior to the installation of the slide hatch 10, the access hatch 10a had a cover 30a that was typically secured by a series of tie-down dogs 39 as shown for the hatch 30a without the slide assembly in FIG. 1. The tie-down dogs 39 had to be manually removed for raising the cover on a hinge. Access to the cover for this task was provided by the ladder 40. With the installation of the slide hatch 10, the hatch cover 30 can be removed and replaced using an activation switch within or outside the truck cab.

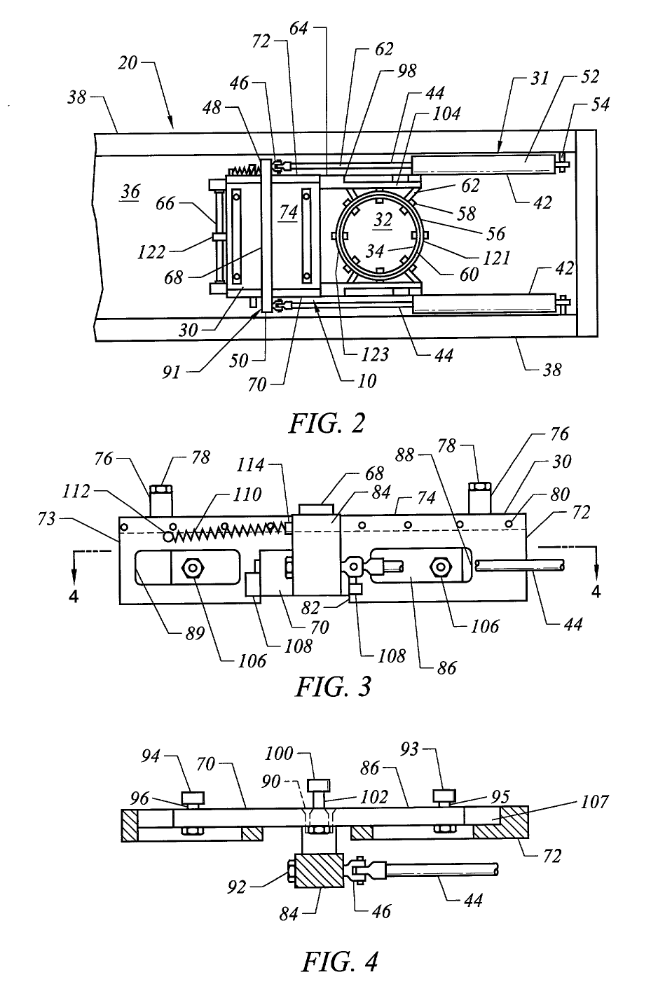

The improved slide hatch 10 is shown in greater detail in FIGS. 2-5. In FIG. 2, the slide hatch 10 is positioned between the two reinforcing beams 38 on each side of the curved top surface 36 of the carrier tank 20. Only this portion of the carrier tank 20 is shown in FIGS. 2-5. The slide hatch 10 in FIG. 2 is shown with the hatch cover 30 displaced from the access port 32 permitting access to the inside of the tank 20 for maintenance, inspection or filling the tank with granular or powdered materials. The hatch cover 30 is connected to a displacement mechanism 31 comprising a pair of spaced pneumatic actuators 42 shown with extended pistons 44 that connect to yoke brackets 46 on each side of the hatch cover 30. Each yoke bracket is connected to a slide carriage 48 that is part of a cam mechanism 50 interconnecting the hatch cover with the displacement mechanism for raising and lowering the hatch cover 30 on the access port 32. The cylinder 52 of the pneumatic actuator 42 is anchored to the frame 25 by pivotal connector pins 54 welded to the reinforcing beams 38. The pistons 44 of the pneumatic actuators 42 are extended and retracted by a pneumatic system (not shown) on the bulk carrier 12.

In the preferred embodiment of this invention, an external collar 56 is mounted around the rim 34 of the access port 32 and secured by a series of uniformly spaced clamping bolts 58. In this arrangement, the collar 56 has a contact rim 60 raised above the original rim 34 of the tank. This arrangement allows the collar rim 60 to be machined for improving the seal of the hatch cover 30 when seated on the collar rim of the modified access port 32. A seal or sealant is interposed between the collar 56 and the wall of the original rim 34 of the access port 32 to prevent any leakage there between.

It is to be understood that this arrangement can be eliminated where the slide hatch is incorporated as original equipment in the manufacture of a transport tank. However, where adapted to existing bulk carriers, it has been found that the original rim may be damaged or not perfectly circular or of uniform dimension. This is only a preferred arrangement and the original rim 34 of the access port 32 can alternately be used by lowering the collar and modifying the seal on the underside of the hatch cover 30.

Welded to the external collar 56 are braces 62 which support a slide track 63 in the form of a pair of guide rails 64 on opposite sides of the access port 32 and parallel to the reinforcement beams 38. The guide rails 64 provide the tracks for guiding the hatch cover 30 over and onto the access port 32. The guide rails 64 comprise part of the cam mechanism 50 and extend to a distal support bracket 66 that is seated on and secured to the top surface of the tank 36 by an adhesive or weld. It is to be noted that the slide carriage 48 is not fixedly connected to the hatch cover 30, but incorporates a cam mechanism bracket 67 allowing a limited relative displacement to increase the coupling force after the slide cover has been properly positioned onto the access port 32.

As shown in FIG. 2, the slide carriage 48 has a cross bar 68 which interconnects two roller assemblies 70 forming part of the cam mechanism 50. One of the two roller assemblies 70 is shown in greater detail in FIGS. 3 and 4. The roller assembly 70 in FIG. 3 is positioned behind a side plate 72 that is fastened to each side of a top plate 74. The two side plates form the cam mechanism bracket 67 on the hatch cover 30. The top plate 74 includes two transverse stiffener bars 76 fastened to the top plate 74 by bolts 78. The stiffener bars 76 prevent any deformation in the top plate 74 when the tank is pressurized during discharge of the contained material. The location of the stiffener bars provides for a firm contact at the fore and aft edges of the rim 60 of the collar 56. The top plate 74 is fixed to the side plate 72 by fasteners 80. It is to be understood that the top plate, side plate and stiffener bars can be incorporated into a single cast hatch cover.

Referring to FIG. 3, the side plate 72 has a notch-like opening 82 to accommodate limited reciprocal travel of a connecting block 84 that interconnects the cross-bar 68 with a carriage plate 86 of the roller assembly 70. The carriage plate 86 also appears through two spaced side slots 88 and 89 in the side plate 72 of the hatch cover 30. The carriage plate 86 and connecting block 84 on each side of the hatch cover 30 interconnected by cross-bar 68 form a coupling device 89 that interconnects the displacement mechanism with the slide carriage and hatch cover.

The top view of the roller assembly 70 in FIG. 4 shows the fixed connection of the carriage plate 86 with the connecting block 84 by fasteners 90. Also shown is the connection of the yoke bracket 46 with the piston 44 of the actuator 42 which is connected to the connecting block 84 by a nut 92. The carriage plate 86 provides a mount for two displaced end rollers 93 and 94 mounted on short shafts 95 and 96 to track on an outer track of a dual tracking arrangement on the guide rail 64. The end rollers 93 and 94 function as cam followers for a cam surface in the form of the slide track. A center roller 100 has a long shaft 102 for tracking on an inner track 104 of the guide rail 64 to stabilize the carriage 48. The end rollers 93 and 94 and the center roller 100 are attached to the carriage plate 86 by end nuts 106. The nut of the center roller 100 is contained in a recess of the connecting block 84 and is not visible. The nuts of the fore end roller 93 and aft end roller 94 are accommodated by the two spaced side slots 88 and 89 in the side plate 72. The carriage plate 86 slides in a recess 107 in the side plate 72.

The relative travel of the carriage 48 to the hatch cover 30 is limited by the stops 108 which contact the connecting block 84 that projects out from the notch-like opening 82 of the side plate 72. The relative positioning of the carriage 48 with the hatch cover 30 is biased to one side by a tension spring 110 having one end connected to a pin 112 on the side plate 72 of the hatch cover 30 and the other end connected to a pin 114.

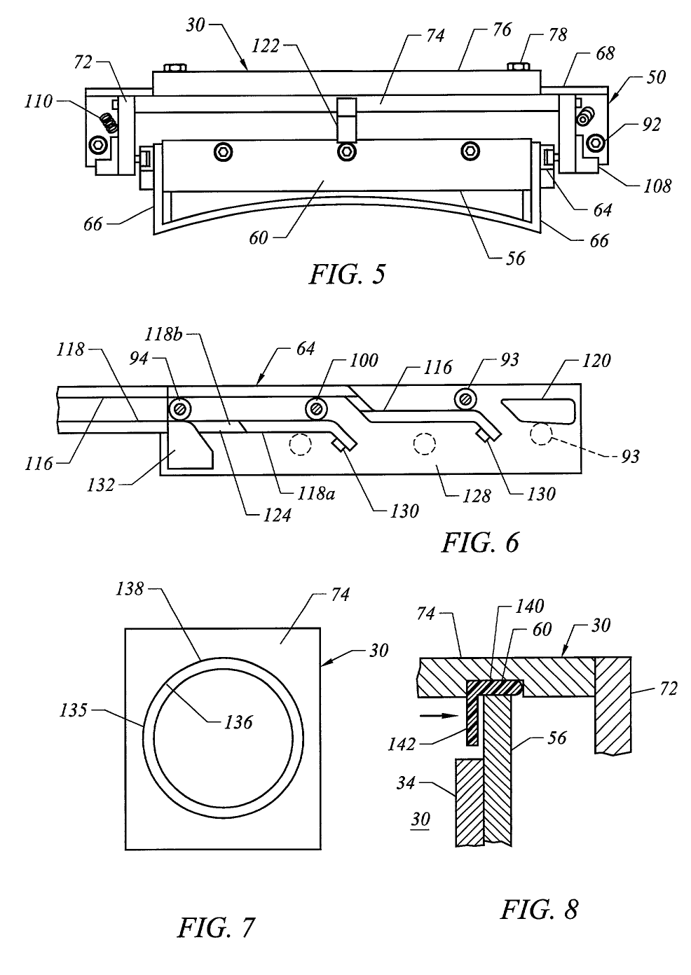

Referring now to the partial end view of the hatch cover 30 and cam mechanism 50 in FIG. 5 and the partial side view of the guide rail 64 in FIG. 6, the operation of the cam mechanism 50 in lowering or raising the hatch cover over the access port can be explained. A guide rail 64 is mounted on each side of the collar 56 and is supported by the collar 56 and end bracket 66. The two end rollers 93 and 94 and the center roller 100 are contained between the upper and lower tracks 116 and 118 respectively, of the guide rail 64. At the portion of the guide rail 64 where the hatch cover 30 is displaced from the access port 32, as shown in FIG. 2, the upper track 116 serves simply to retain the hatch cover onto the cam mechanism 50. The rollers ride on the lower track 118 during displacement until the rollers arrive at the section of the guide rail 64 adjacent the access port 32, as shown in FIG. 6.

At that point, the tracks 116 and 118 are configured to allow the roller assemblies 70, here depicted schematically only by the individual rollers 93, 94 and 100, to drop to their position shown in dotted line. Here the fore end roller 93 wedges under a downwardly sloped end block 120 at the fore side 121 of the access port 32 and the aft end roller 94 wedges under a downwardly sloping rail segment 118a on the underside of the track 118 at the aft side 123 of the access port. Notably, an end stop 122 on the hatch cover 30 has contacted the collar 56 for precision placement of the hatch cover 30 onto the collar rim 60. With the hatch cover positioned over the access port 32 and further horizontal displacement prevented by the stop 122, a further displacement of the carriage 48 by retraction of the piston 44 in the cylinder 52 of the actuator 42 causes an increase in the wedge effect of the rollers 93 and 94 against the slide track formed by the end block 120 and rail segment 118a to further tighten the hatch cover 30 on the collar 56. To prevent the front end of the carriage 48 from prematurely dipping into its clamping position, the center roller 100 having the long shaft 102 rides over a ledge or inside track 118b adjacent a slot 124 into which the trailing or aft roller 94 eventually drops for its locking position.

It is to be understood that the function of the center roller 100 is to maintain the horizontal orientation of the carriage 48 until both rollers 93 and 94 are positioned to descend to their clamping position in contact with the underside of the track 118a and the block 120 of the guide rail 64. In the clamping position, the center roller 100 located in the vicinity of the transverse center line of the access port 32 does not contact the underside of the track 116 or contribute to the clamping force.

In this manner, the cam mechanism 50 provides the hatch cover with a fore and aft clamping force on the respective fore and aft sides of the access port 32. This split force is then distributed around the rim of the collar or original rim of the access port. It is to be understood that when using the term rim of the access port, the terminology refers both to the original rim of the access port or the raised rim of the collar where the original rim is not suitable for a secured sealing of the cover clamped to the access port.

The terminal ends of the upper track 116 and lower track 118 are fixed to a mounting plate 128 by support blocks 130. The end track block 120 and sloping track block 132 adjacent the opening 124 are directly secured to the mounting plate 128 by back fasteners (not visible). It is to be understood that other configurations for the cam mechanism 50 with cam means other than rollers and rails can be devised to transmit a compressive force directed from the for and aft portion of the hatch cover 30 to the fore and aft portions of the rim of the access port.

The underside of the top plate 74 of the hatch cover 30 has a sealing seat 135 formed by a circular recess 136 for insertion of a circular seal 138. The seal 138 may simply be a flat seal extending slightly from the surface of the underside of the top plate 74 or may include a cross-section having a flap as shown in FIG. 8.

Referring to FIG. 8, a modified seal 140 is shown installed on a cross-sectional segment of the top plate 74 of the hatch cover 30. The hatch cover 30 is shown seated on a portion of the rim 60 of the collar 56 connected to the original inner rim 34 of the access port 32. The circular seal 140 has an integral inside flap 142 which seats against the inside surface 144 of the collar 56 when an internal pressure is generated in the tank 20 causing pressure to be applied against the flap 142 by the directional arrow in FIG. 8. In most instances where the original rim 34 or rim 60 of the collar 56 is newly machined, the added sealing provided by a seal having a flap-type configuration is not required. However, the self-sealing seal shown in FIG. 8 or other equivalent self-sealing seal can be utilized to enhance sealing.

While in the foregoing, embodiments of the present invention have been set forth in considerable detail for the purposes of making a complete disclosure of the invention, it may be apparent to those of skill in the art that numerous changes may be made in such detail without departing from the spirit and principles of the invention.

1. A slide hatch for a bulk carrier vehicle having a tank with a tank top with at least one access port having fore and aft sides with a rim raised from the tank top, the slide hatch comprising:
a hatch cover having a top and an underside with a sealing seat engageable with the rim of the access port when the cover is seated on the access port;
a hatch cover slide apparatus mountable on the tank having:
a displacement mechanism including:
a slide track;
a slide carriage slidably engaged with the slide track and displaceable thereon; and
an actuator connected to the slide carriage; and,
a cam mechanism interconnecting the hatch cover with the displacement mechanism, wherein the cam mechanism includes a cam mechanism bracket on the hatch cover and a coupling device engaging the cover and the cam mechanism bracket, the coupling device being connected to the displacement mechanism, wherein the actuator of the displacement mechanism displaces the slide carriage and hatch cover between a first position over the access port and a second position displaced from the access port, and wherein the cam mechanism seals the hatch cover on the access port when the hatch cover is positioned over the access port, wherein the cam mechanism is improved with a slide carriage having fore and aft contact members that engage the slide track at the fore and aft sides of the access port to distribute the clamping force of the hatch cover on the rim on both the fore and aft sides of the hatch cover.

2. The slide hatch of claim 1 wherein the slide track includes at least one guide rail and the cam mechanism includes fore and aft followers connected to the slide carriage that tracks along the guide rail when the slide carriage is displaced, wherein the guide rail has multiple inclinations that engage the fore and aft followers that lower the hatch cover onto the access port when the slide carriage is displaced toward the access port.

3. The slide hatch of claim 2 wherein the slide track includes first and second parallel slide rails mountable on opposite sides of the access port.

4. The slide hatch of claim 2 wherein the rail followers comprise rollers.

5. The slide hatch of claim 4 wherein the slide carriage includes a pair of carriage plates for mounting track followers, the slide track includes a pair of guide rails, and the cam mechanism includes a plurality of rail followers connected on each plate of the slide carriage, each rail follower engaging a guide rail, wherein the guide rails have an inclination that lowers the hatch cover onto the access port when the slide carriage is displaced toward the access port.

6. The slide hatch of claim 5 wherein the guide rails of the slide track include wedge members at the fore and aft sides of the access port under which the rail followers position on positioning the hatch cover onto the access port.

7. The slide hatch of claim 5 wherein the hatch cover includes a cover plate and the cam mechanism bracket comprises a pair of side plates fixed to opposite sides of the cover plate, the side plates each having a notch positioned between the side plates with a pair of oppositely positioned blocks projecting through the notches, wherein the blocks have a width narrower than the width of the notches and wherein limited displacement of the slide carriage relative to the hatch cover is enabled on displacement of the slide carriage by the actuator.

8. The slide hatch of claim 1 wherein the actuator comprises a pneumatic piston and cylinder unit.

9. The slide hatch of claim 5 wherein the blocks include a cross bar over the cover plate of the hatch cover interconnecting the blocks.

10. The slide hatch of claim 5 wherein the hatch cover includes a stop that contacts the rim of the access port when the cover is positioned over the access port.

11. The slide hatch of claim 9 wherein the hatch cover and slide carriage include an interconnecting tension spring for biasing the relative limited displacement of the hatch cover relative to the slide carriage.

12. In a bulk carrier vehicle having a carrier tank with at least one top access hatch with an access port and a hatch cover, a hatch cover slide apparatus comprising:
a slide track having means for mounting the slide track on the carrier tank proximate the access port;
a slide carriage having a track follower engaging the slide track wherein the slide carriage is slidable on the slide track;
connecting means for connecting the hatch cover to the slide carriage;
actuator means for displacing the slide carriage on the slide track wherein the slide track has a horizontal portion and an incline portion that vertically displaces the hatch cover relative to the access port;
positioning means for positioning the hatch cover over the access port when the hatch cover is vertically displaced relative to the access port; and
a sealing means including a self-sealing flap that reacts to pressurization of the tank for improved sealing.

13. In a bulk carrier vehicle having a carrier tank with at least one top access hatch with an access port having fore and aft sides and a hatch cover, a hatch cover slide apparatus comprising:
a slide track having means for mounting the slide track on the carrier tank proximate the access port;
a slide carriage having a plurality of displaced track follower engaging the slide track wherein the slide carriage is slidable on the slide track;
connecting means for connecting the hatch cover to the slide carriage;
actuator means for displacing the slide carriage on the slide track wherein the slide track has a horizontal portion and an incline portion that vertically displaces the hatch cover relative to the access port;
positioning means for positioning the hatch cover over the access port when the hatch cover is vertically displaced relative to the access port wherein the displaced track followers are positioned on both the fore and aft sides of the access port in engagement with wedge clamping means for distributing clamping forces of the hatch cover on the access port.
